(19) United States
(12) Patent Application Publication
(10) Pub. No.: US 2009/0309393 A1
(43) Pub. Date: Dec. 17, 2009

(54) WIND DEFLECTOR

(76) Inventors: Johann Pihale, Oberbrunn (DE); Andreas Sedlmeir, Utting (DE)

Correspondence Address: DICKINSON WRIGHT PLLC, 1875 Eye Street, NW, Suite 1200, WASHINGTON, DC, 20006, US

(21) Appl. No.: 12/279,265

(22) PCT Filed: Jan. 25, 2007
(86) PCT No.: PCT/DE07/00157

§ 371 Date: Dec. 10, 2008

(30) Foreign Application Priority Data
Feb. 13, 2006 (DE) 10 2006 006 553.0

(51) Int. Cl. B60J 7/22

(52) U.S. Cl. 296/217

(57) ABSTRACT

The invention relates to a wind deflector for a vehicle roof comprising a roof opening (14) which can be closed by means of a displaceable cover element (16), said wind deflector comprising a deflector element (20) which is arranged along a front edge (17) of the roof opening (14) and can be displaced between a lowered inoperative position and a deployed operating position, in which there is a gap between the deflector element (20) and the front edge (17) of the roof opening (14) for the flow to pass under the deflector element (20), wherein at least one turbulence-generating device (24) made of a foldable flat material is arranged between the deflector element (20) and the front edge (17) of the roof opening (14), in the mounted state, said turbulence-generating device being effective when the flow passes under the deflector element (20), being arranged in the path of the flow passing under the deflector element (20) in the deployed operating position thereof and being deposited in a folded manner in the lowered inoperative position of the deflector element (20). According to the invention, the turbulence-generating device (24) can be displaced in the transverse direction of the vehicle in order to optimize the booming behaviour.

The invention relates to a wind deflector for a vehicle roof according to the precharacterizing clause of patent claim 1.

A wind deflector of this type is known from DE 101 36 922 A1 and serves to upwardly deflect air which approaches it while the vehicle in question is underway such that, when the roof opening is open, the flow is prevented from directly approaching vehicle occupants and the noise caused by the approaching air is reduced.

The wind deflector known from DE 101 36 922 A1 comprises a deflector element which extends along a front edge of the roof opening and can be displaced between a lower inoperative position and a first, central and a second, deployed operative position. In the second operative position, there is a gap between the deflector element and the front edge of the roof opening. This operative position of the deflector element is set in particular when the speed of the vehicle is between 50 and 70 km/h and it is desirable for some of the approaching air to be directed through the roof opening into the vehicle interior, this being achieved in this operative position by the flow passing under the deflector element. In order to counter the problem of rumbling, i.e. formation of a stationary oscillation of air in the vehicle interior, in this speed range, the known wind deflector has, between the deflector element and the front edge of the roof opening, a plurality of turbulence-generating devices in the form of flexible fabric straps, which, in the second, deployed operative position of the deflector element, lie in the path of the flow passing under the deflector element and are effective when the flow passes under the deflector element. The fabric straps are deposited in folded form below the level of a fixed roof skin in the lowered inoperative position of the deflector element.

Since rumbling noises depend substantially on the particular geometry of the vehicle, the known wind deflector has to be designed separately for each type of vehicle. However, this is associated with a high cost outlay.

The invention is based on the object of providing a deflector element of the generic type mentioned in the introduction, which can be adapted in a simple manner to different types of vehicle.

This object is achieved according to the invention by the wind deflector with the features of patent claim 1.

Consequently, the core of the invention resides in providing a wind deflector which comprises, between a deflector element and a front edge of a roof opening, at least one turbulent-generating device made of a foldable, flexible flat material, the position of which can be changed in the transverse direction of the vehicle. Since the strength of the rumbling noise is also dependent on the positioning of the turbulence-generating device in the transverse direction of the vehicle, when the wind deflector according to the invention is used, optimization can be achieved with regard to the types of vehicle present in each case by means of displacement of the foldable flat material, which stretches open when the deflector element is deployed, in the transverse direction of the vehicle. The costs of adjusting a wind deflector can therefore be reduced. Furthermore, the wind deflector according to the invention requires less construction space than a wind deflector with fixed turbulence-generating devices.

The foldable flat material can be formed in particular from an air-permeable or air-tight fabric or a film. For example, the fabric is a stretch material. However, it may also be a net-like material.

The wind deflector according to the invention preferably has a plurality of strips of the foldable flat material, which, when the deflector element is deployed, are each clamped between the latter and the front edge of the roof opening. The individual strips can be positioned in a variable manner and, if appropriate, can be fixed according to the exact positioning. To optimize, i.e. to reduce, the rumbling noise, the distance between the individual strips is adjusted as a function of the type of vehicle.

In principle, the number of turbulence-generating devices is variable and can be matched to the particular use conditions.

The wind deflector according to the invention is designed in particular in such a manner that the extent to which the deflector element is deployed can be matched to the vehicle speed. For this purpose, the deflector element is preferably provided with an adjustment device which acts in the vertical direction. For example, at speeds of up to 70 km/h, the deflector element takes up the deployment position in which there is gap between the deflector element and the front edge of the roof opening, through which gap the flow can pass under the deflector element. At higher speeds, the deflector element is lowered to an extent such that the gap is closed and the flow passing under the deflector element is interrupted. In this case, the turbulence-generating devices may be a retaining strap of the wind deflector drive, which retaining strap is connected to the deflector element.

In order to be able to adjust the turbulence-generating device in a simple manner, in the preferred embodiment of the wind deflector according to the invention, the deflector element has at least one rail on its lower side for guiding the turbulence-generating device. An opposite rail fixed on the roof is preferably also provided in the region of the front edge of the roof opening.

An embodiment of the wind deflector according to the invention that can be realized in a simple manner structurally is provided if the rails are each designed in the manner of a C profile.

For fixing in the rails, the turbulence-generating device has, at its upper edge and its lower edge, a respective weatherstrip-like bead which engages in the respectively assigned rail.

In an embodiment of the wind deflector according to the invention that can be produced cost-effectively, the weatherstrip-like bead is formed in each case from a profile which is sprayed onto the foldable flat material. The profile may have a round or else angular cross section. As an alternative, however, the weatherstrip-like bead may also be formed in a simple manner by means of a cord or the like sewn into an edge pocket of the foldable flat material.

In order to ensure that the turbulence-generating device is not displaced after it has been adjusted, i.e. matched to the particular geometry of the vehicle, fixing devices for the turbulence-generating device can be provided on the rails which are formed on the deflector element and are fixed on the roof. However, fixing in the transverse direction of the invention may also already be provided by the weatherstrip-like bead being arranged such that it fits closely in the respectively assigned rail or guide and, consequently, the turbulence-generating device can be displaced in the transverse direction of the vehicle only with considerably effort. In this case, the foldable and flexible flat material preferably at least engages over the weatherstrip-like bead.

Further advantages and advantageous refinements of the subject according to the invention can be found in the description, the drawing and the patent claims.

An exemplary embodiment of a wind deflector according to the invention is illustrated in simplified form schematically in the drawing and is explained in more detail in the description below. In the drawing

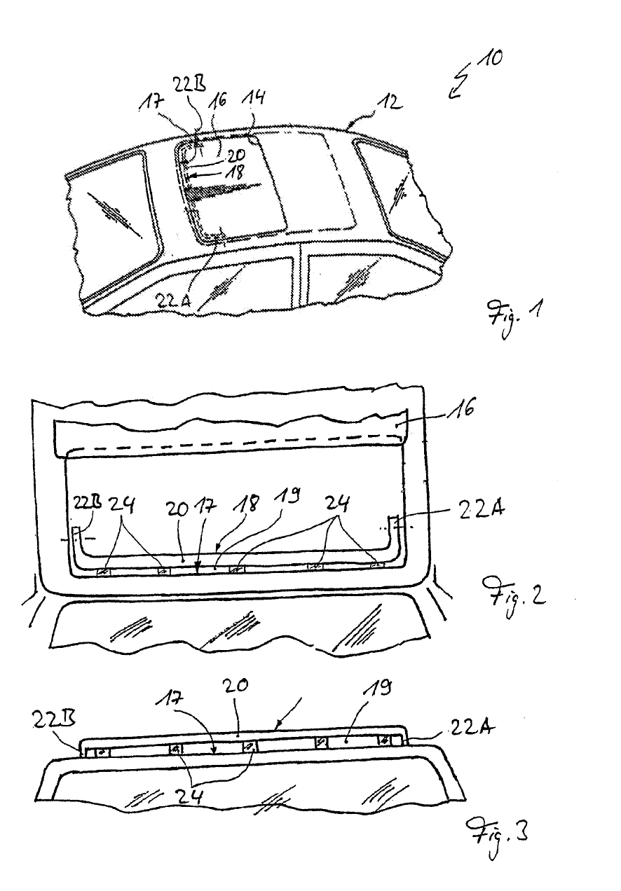

FIG. 1 shows a perspective top view of a vehicle roof with a wind deflector designed according to the invention;

FIG. 2 shows a top view of the vehicle roof with the cover element open;

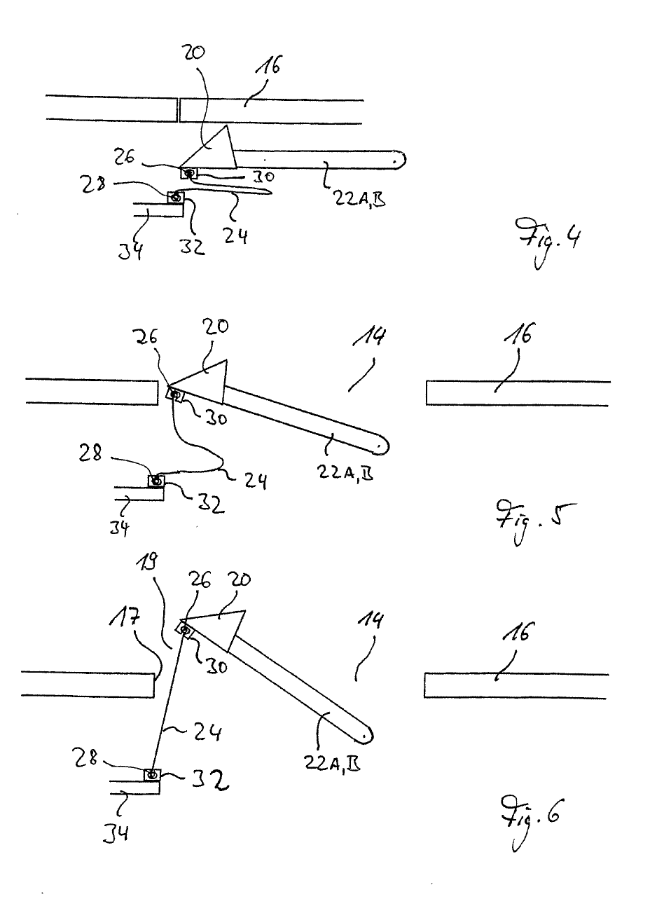

FIG. 3 shows a front view of the vehicle roof with the wind deflector deployed;

FIG. 4 shows a longitudinal section through the vehicle roof with a wind deflector in an inoperative position;

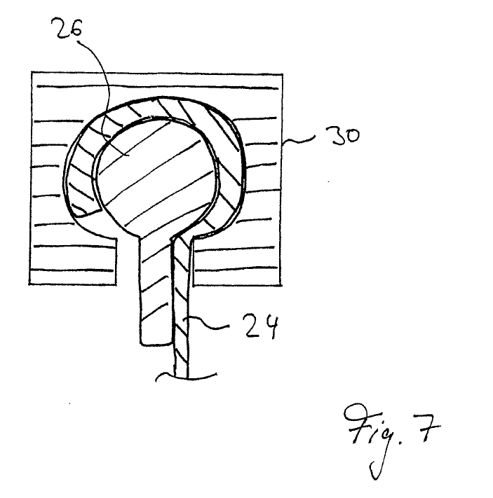

FIG. 5 shows a view corresponding to FIG. 4 of the wind deflector in a first operative position; and

FIG. 6 shows a view corresponding to FIG. 4 of the wind deflector in a second operative position, and

FIG. 7 shows an enlarged view of the engagement of a turbulence-generating device in a rail.

FIG. 1 illustrates a motor vehicle 10 which has a vehicle roof 12 with a roof opening 14 which can optionally be closed or can be at least partially opened up by means of a cover element 16 which can be displaced in the longitudinal direction of the vehicle.

A wind deflector 18 is arranged in the region of a front edge of the roof opening 14, the wind deflector having a deflector element 20 which runs along the front edge 17 of the roof opening 14 and is respectively connected at its lateral ends to a deployment arm 22A or 22B which is pivotably connected at its end facing away from the deflector element 20 to a sliding roof frame (not illustrated specifically here).

The wind deflector 18 is prestressed in the deployment direction by means of spring elements (likewise not illustrated specifically here) which act on the deployment arms 22A, 22B.

The wind deflector 18 can be displaced between an inoperative position, in which it lies below the cover element 16 when the latter is closed, and at least one operative position, in which it is raised above the roof contour, as can be seen in FIGS. 4 to 6. The respective operative position is set by means of a retaining element which is joined to the deflector element 20, acts in the vertical direction and is connected to a control mechanism operating as a function of speed.

In the operative position which is illustrated in FIGS. 2, 3 and 6 and is raised above the roof contour, the turbulence-generating devices 24 lie in the flow path of the air passing under the deflector element 20. The turbulence-generating devices 24 are each formed from strips of fabric strap and, consequently, are formed from a foldable flat material. Depending on the application, the fabric strap can be of air-tight or else air-permeable design. In particular, a stretch material can be used.

In principle, the individual fabric strips of the turbulence-generating devices 24 can have different widths.

As can be gathered from FIGS. 4 to 6, the turbulence-generating devices 24 have, at their upper edges and their lower edges, respective weatherstrip-like beads 26 and 28 which are formed from a rubber profile sprayed onto the foldable flat material and engage in a respective rail 30 and 32 formed in the manner of a C profile. As an alternative, the rubber profile may also be sewn, adhesively bonded or clipped onto the fabric or connected to the fabric by another method. The turbulence-generating devices 24 can thus be displaced in the transverse direction of the vehicle. In this case, the fabric of the turbulence-generating devices 24 engages in each case over the profile forming the weatherstrip-like bead, as can be gathered in particular from FIG. 7. The fixing in the rails 30 and 32 enables the turbulence-generating devices 24 to be of displaceable design in the transverse direction of the vehicle.

In the inoperative position illustrated in FIG. 4, the deflector element 20 takes up its lower inoperative position in which it is pulled back fully into the roof contour where it is completely covered by the closed cover element 16. In this inoperative position, the turbulence-generating devices 24 are accommodated folded below the deflector element 20 in a corresponding receiving space.

In the first operative position, which is illustrated in FIG. 5, a deflector element 20 is deployed in such a manner that the approaching air can only pass over, but not under the deflector element 20. The turbulence-generating devices 24 formed from the various straps hang slackly between the deflector element 20 and a front part 34 of the sliding roof frame, which part is arranged in the region of the front edge 17 of the roof opening 14. This operative position is selected at high vehicle speeds.

In the second operative position, which is illustrated in FIG. 6, of the deflector element 20, there is a gap 19 extending in the transverse direction of the vehicle between the deflector element 20 and the front edge 17 of the roof opening 14 such that the flow can pass over and also under the deflector element 20. In this operative position, the flexible straps of the turbulence-generating devices 24 are fully tensioned, and therefore do not flap when the flow passes under the deflector element 20. By means of the turbulence-generating devices 24, the air flow passing under the deflector element 20 is swirled, as a result of which rumbling in the interior of the vehicle is substantially prevented. This operative position is selected at medium traveling speeds, for example in a speed range of between 50 and 70 km/h.

### REFERENCE NUMBERS

10 motor vehicle

12 vehicle roof

14 roof opening

16 cover element

17 front edge

18 wind deflector

19 gap

20 deflector element

22A, 22B deployment arm

24 turbulence-generating device

26 weatherstrip-like bead

28 weatherstrip-like bead

30 rail

32 rail

34 frame front part

1. A wind deflector for a vehicle roof with a roof opening which can be closed by means of a displaceable cover element, the wind deflector comprising a deflector element which is arranged along a front edge of the roof opening and can be displaced between a lowered inoperative position and a deployed operative position in which there is a gap between the deflector element and the front edge of the roof opening for the flow to pass under the deflector element, wherein at least one turbulence-generating device made of a foldable, flexible flat material is arranged between the deflector element and the front edge of the roof opening, which turbulence-generating device is effective when the flow passes under the deflector element, is arranged in the path of the flow passing under the deflector element in the deployed operative position thereof and is deposited in folded form in the lowered inoperative position of the deflector element, characterized in that the turbulence-generating device can be displaced in the transverse direction of the vehicle.

2. The wind deflector of claim 1, characterized in that the deflector element has at least one rail on its lower side for guiding the turbulence-generating device, and a rail which is fixed on the roof and is intended for guiding the turbulence-generating device is provided in the region of the front edge of the roof opening.

3. The wind deflector of claim 2, characterized in that the rails are each designed in the manner of a C profile.

4. The wind deflector of claim 2, characterized in that the turbulence-generating device has, on its upper edge and on its lower edge, a respective weatherstrip-like bead which engages in the respectively assigned rail.

5. The wind deflector of claim 4, characterized in that the weatherstrip-like bead is in each case formed from a profile which is sprayed, adhesively bonded or sewn onto the foldable flat material.

6. The wind deflector of claim 1, characterized by a releasable fixing device for the turbulence-generating device which prevents the displacement thereof in the transverse direction of the vehicle.
